(19) United States
(12) Patent Application Publication
(10) Pub. No.: US 2026/0369945 A1
(43) Pub. Date: Nov. 19, 2026

(54) CRIMPING PLIERS

(71) Applicant: Wenzhi LUO, Shaoguan (CN)

(72) Inventor: Wenzhi LUO, Shaoguan (CN)

(21) Appl. No.: 19/724,956

(22) Filed: Jun. 30, 2026

(30) Foreign Application Priority Data
Jun. 22, 2026 (CN) 202620929346.8

(51) Int. Cl. H01R 43/042; B21D 39/04

(52) U.S. Cl. CPC H01R 43/042; B21D 39/048

(57) ABSTRACT

Crimping pliers, including: a jaw assembly, a handle assembly, a pivoting assembly, an elastic limiting assembly and a spare clamping block. The jaw assembly is provided with at least two oppositely arranged and detachable clamping blocks. The jaw assembly has a clamping state and an open state. In the clamping state, the at least two clamping blocks clamp against each other or against other components of the jaw assembly. The handle assembly is connected to the jaw assembly, and configured to drive the jaw assembly to switch between the clamping state and the open state upon application of an external force. The pivoting assembly pivotably connects the jaw assembly and the handle assembly. The elastic limiting assembly is fixed to the handle assembly and located within the receiving groove. The spare clamping block is detachably snap-fitted to the elastic limiting assembly and located within the receiving groove.

### CROSS REFERENCE TO RELATED APPLICATIONS

This application claims foreign priority of Chinese Patent Application No. 202620929346.8, filed on Jun. 22, 2026 in the China National Intellectual Property Administration, the disclosures of all of which are hereby incorporated by reference.

### TECHNICAL FIELD

The present disclosure relates to the technical field of crimping tools, in particular to crimping pliers.

### BACKGROUND

Crimping pliers are a specialized tool used for crimping metal terminals onto wires. They are widely employed in various fields, such as electrical wiring, network cabling, automotive maintenance, and the like. During crimping operations, it is typically necessary to replace the crimping blocks (also referred to as crimping dies) with different sizes according to the specific terminal models and wire diameters.

In conventional crimping pliers, the crimping blocks are typically fixed to the jaw portions by screws. Replacing the crimping blocks requires additional tools such as screwdrivers for disassembly and reassembly, which is inconvenient and time-consuming. Moreover, the spare crimping blocks are prone to being lost during the replacement process. In addition, when working on site, users frequently need to carry crimping blocks of multiple sizes. However, carrying these blocks separately makes them susceptible to scattering or loss. Therefore, integrating a storage function for spare crimping blocks directly onto the crimping pliers, while ensuring convenient access and reliable fixation, has become an urgent technical problem to be solved in the art.

### SUMMARY

The purpose of the present disclosure is to provide a solution that facilitates improvement of the convenience of disassembly and assembly of spare crimping blocks for crimping pliers.

To realize the above objective, the present disclosure provides crimping pliers, including: a jaw assembly provided with at least two oppositely arranged and detachable clamping blocks, the jaw assembly has a clamping state and an open state, in the clamping state, the at least two clamping blocks clamp against each other or against other components of the jaw assembly; a handle assembly connected to the jaw assembly, the handle assembly is configured to drive the jaw assembly to switch between the clamping state and the open state upon application of an external force, and wherein the handle assembly defines a receiving groove; a pivoting assembly pivotably connecting the jaw assembly and the handle assembly; an elastic limiting assembly fixed to the handle assembly and located within the receiving groove; a spare clamping block detachably snap-fitted to the elastic limiting assembly and located within the receiving groove.

The present disclosure has the following beneficial effects: by providing a receiving groove and an elastic limiting assembly on the handle assembly, the spare crimping block can be conveniently snap-fitted and fixed on the handle assembly, and can be accessed and stored without additional tools. The elastic limiting assembly can not only provide sufficient clamping force to prevent the spare crimping block from falling off, but also realize quick disassembly and assembly through elastic deformation, thereby improving the convenience of use of the crimping pliers and the management efficiency of spare parts.

The present disclosure will be further described in detail below with reference to the accompanying drawings and specific embodiments.

### BRIEF DESCRIPTION OF THE DRAWINGS

FIG. 1 is a schematic structural diagram of a jaw assembly of crimping pliers according to an embodiment of the present disclosure in a clamped state.

FIG. 2 is a schematic structural diagram of the jaw assembly of the crimping pliers according to an embodiment of the present disclosure in an opened state.

FIG. 3 is a schematic structural diagram of the crimping pliers according to an embodiment of the present disclosure.

FIG. 4 is a schematic structural diagram of the crimping pliers according to an embodiment of the present disclosure from another perspective.

FIG. 5 is an exploded view of the crimping pliers in FIG. 4.

FIG. 6 is a partial structural schematic diagram of the crimping pliers according to an embodiment of the present disclosure.

FIG. 7 is a side view of a spare clamping block of the crimping pliers according to an embodiment of the present disclosure.

FIG. 8 is an enlarged view of portion A in FIG. 6.

FIG. 9 is an exploded view of an elastic limiting assembly of an embodiment of the present disclosure.

FIG. 10 is a schematic structural diagram of an assembled state of the elastic limiting assembly and the spare clamping block of an embodiment of the present disclosure.

FIG. 11 is an exploded view of the crimping pliers according to an embodiment of the present disclosure.

FIG. 12 is a schematic structural diagram of the crimping pliers according to an embodiment of the present disclosure from yet another perspective.

FIG. 13 is an enlarged view of a portion enclosed by a dashed line in FIG. 11.

### DESCRIPTION OF THE REFERENCE NUMERALS

| | reference | | reference |
|---|---|---|---|
| Description | numerals | Description | numerals |
| crimping pliers | 100 | elastic limiting | 40 |
| | | assembly | |
| jaw assembly | 10 | fixing component | 41 |
| clamping block | 11 | connecting component | 42 |
| insertion port | 111 | first part | 421 |
| locking circular hole | 1111 | second part | 422 |
| mounting recess | 12 | limiting protrusion | 43 |
| rotary locking shaft | 13 | guiding portion | 431 |
| locking block | 131 | first guiding surface | 4311 |
| operating knob | 14 | second guiding surface | 4312 |
| spring plate | 15 | spare clamping block | 50 |
| planar contact | 151 | limiting groove | 51 |
| portion | | | |
| clamping groove | 16 | opening | 511 |
| slice slot | 161 | mating surface | 5112 |
| handle assembly | 20 | channel portion | 512 |
| handle arm | 21 | limiting portion | 513 |
| receiving groove | 211 | first wall | 52 |
| first fixing | 22 | second wall | 53 |
| component | | | |
| second fixing | 23 | top cover | 60 |
| component | | | |
| spacer | 24 | spring | 70 |
| pivoting assembly | 30 | | |

### DETAILED DESCRIPTION OF THE EMBODIMENTS

The technical solutions in the embodiments of the present disclosure will be described below with reference to the accompanying drawings in the embodiments of the present disclosure. Obviously, the described embodiments are only a part of the embodiments of the present disclosure, rather than all of the embodiments.

It should be noted that, unless otherwise expressly specified and defined, the terms “mount,” “connect,” “link,” “fix,” and the like should be understood in a broad sense. For example, it may be a fixed connection, a detachable connection, or an integral connection. When a component is considered to be “connected to” another component, it may be directly connected to the other component or there may be an intervening component present simultaneously. When a component is considered to be “disposed on” another component, it may be directly disposed on the other component or there may be an intervening component present simultaneously.

Unless otherwise specified, the term “plurality” as used herein refers to two or more.

The terms “first,” “second,” and the like are used merely to distinguish different objects and are not to be construed as indicating or implying relative importance or implicitly indicating the number, specific order, or primary/secondary relationship of the indicated technical features.

The term “vertical” is used to describe an ideal state between two components. In actual production or use, an approximately vertical state may exist between the two components. For example, when described with numerical values, vertical may refer to an angle between two straight lines falling within the range of 90°+10°, vertical may refer to a dihedral angle between two planes falling within the range of 90°+10°, and vertical may also refer to an angle between a straight line and a plane falling within the range of 90°+10°.

It should be understood that the dimensions of the various components shown in the drawings are provided for better understanding and more convenient description, and the present disclosure is not limited to the dimensions shown in the drawings. To make the present invention clear, elements irrelevant to the description are omitted from the details of this specification.

Unless otherwise defined, all technical and scientific terms used herein have the same meaning as commonly understood by those skilled in the art to which the present disclosure belongs. The terms used in the specification of the present disclosure herein are for the purpose of describing specific embodiments only and are not intended to limit the present disclosure.

Some embodiments of the present disclosure will be described below with reference to the accompanying drawings. The following embodiments and features in the embodiments may be combined with each other without conflict.

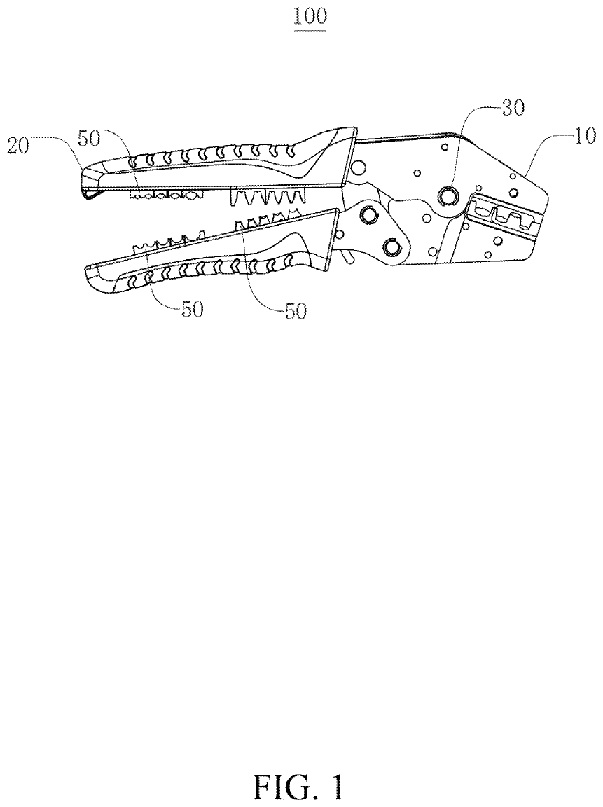

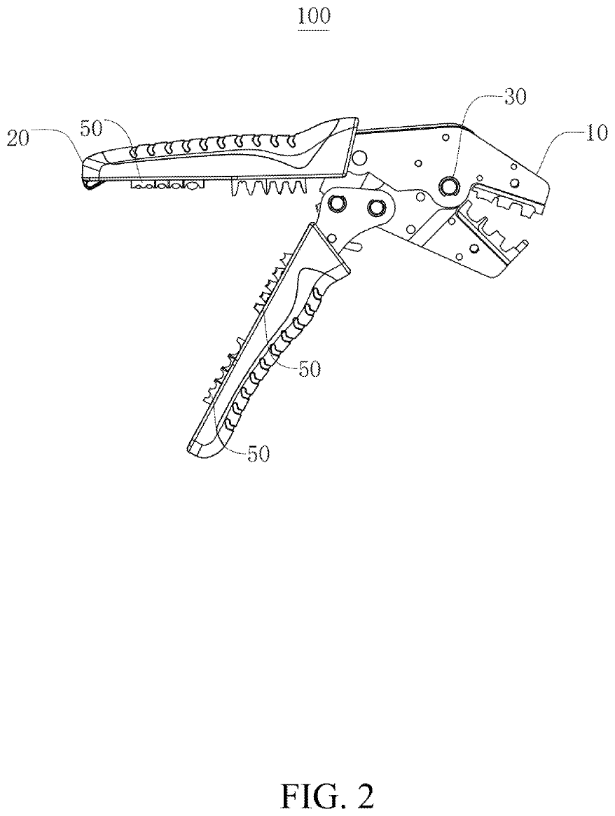

Referring to FIG. 1 and FIG. 2, an embodiment of the present disclosure provides crimping pliers 100. The crimping pliers 100 includes a jaw assembly 10, a handle assembly 20, a pivoting assembly 30, and a spare clamping block 50. The jaw assembly 10 is configured to have a clamping state and an open state, and the jaw assembly 10 is provided with at least two oppositely disposed and detachable clamping blocks 11. The jaw assembly 10 is connected to the handle assembly 20, and the handle assembly 20 is configured to move under an external force, thereby driving the jaw assembly 10 to switch between the clamping state and the open state. The pivoting assembly 30 is arranged at the connection between the jaw assembly 10 and the handle assembly 20, thereby enabling the crimping pliers 100 to perform a crimping action. The spare clamping block 50 is detachably connected to the handle assembly 20.

It should be noted that, when the jaw assembly 10 is in the clamping state, the two oppositely disposed clamping blocks 11 approach each other and clamp a terminal or a wire. In the open state, the two clamping blocks 11 move away from each other, allowing a workpiece to be placed in or taken out.

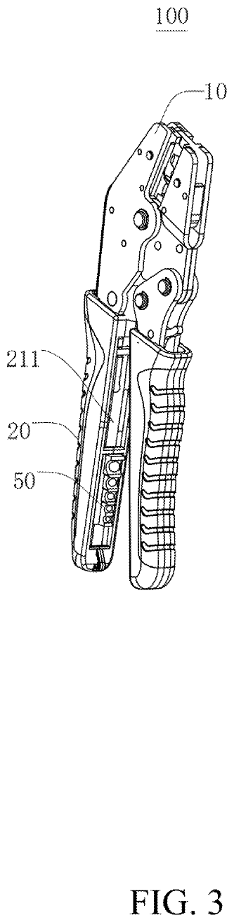

In some embodiments, referring to FIG. 3, the handle assembly 20 is provided with a receiving groove 211 for accommodating the spare clamping block 50.

In some embodiments, referring to FIG. 3 to FIG. 5, the crimping pliers 100 further includes an elastic limiting assembly 40 fixed to the handle assembly 20 and located inside the receiving groove 211. The spare clamping block 50 is detachably engaged with and secured by the elastic limiting assembly 40 and is at least partially located within the receiving groove 211.

It is worth mentioning that, in actual use, a user can pre-install spare clamping blocks 50 of different sizes into the receiving groove 211 in advance and secure them by means of the elastic deformation force of the elastic limiting assembly 40. When it is necessary to replace the clamping blocks 11, the user can directly pull the spare clamping blocks 50 out from the receiving groove 211 and then install them on the jaw assembly 10. This design ensures that the spare clamping blocks 50 always remain with the main body of the crimping pliers 100, is not easily lost, and is convenient to access without requiring additional tools.

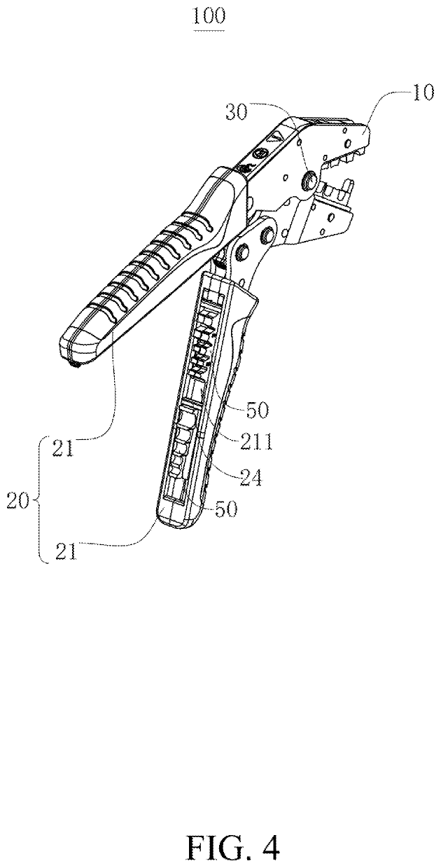

In some embodiments, referring to FIG. 4, the handle assembly 20 includes two handle arms 21. The two handle arms 21 are configured to be able to approach and move away from each other, thereby driving the jaw assembly 10 to switch between the clamping state and the open state. At least one of the handle arms 21 is provided with a receiving groove 211, and each receiving groove 211 is provided with at least one elastic limiting assembly 40.

In some embodiments, both of the two handle arms 21 may be provided with receiving grooves 211 to accommodate more spare clamping blocks 50. For example, one of the two handle arms 21 is configured to store spare clamping blocks 50 of one size, and the other handle arm 21 is configured to store spare clamping blocks 50 of another size. As another example, one of the two handle arms 21 is configured to store multiple spare clamping blocks 50 of different sizes, and the other handle arm 21 is also configured to store multiple spare clamping blocks 50 of different sizes.

In some embodiments, the number of elastic limiting assemblies 40 in each receiving groove 211 may be one or more, depending on the number of spare clamping blocks 50.

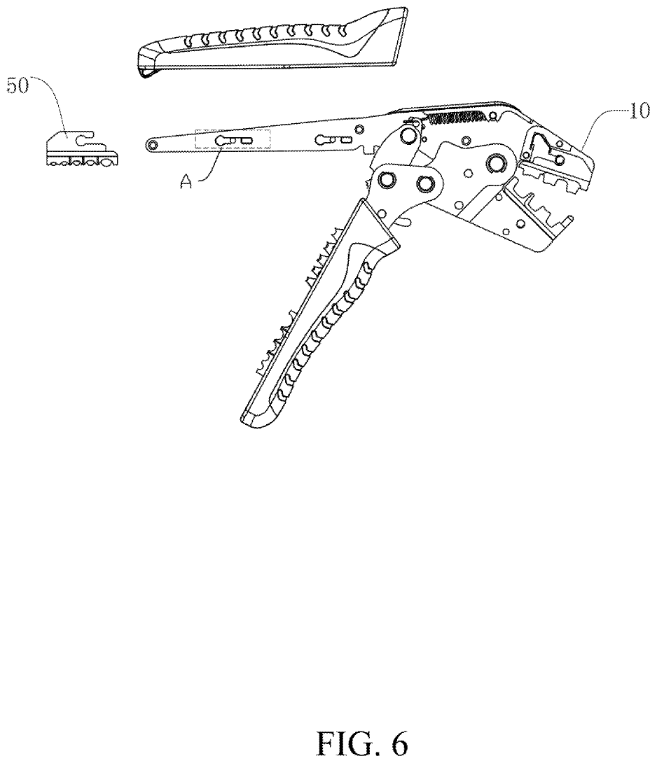

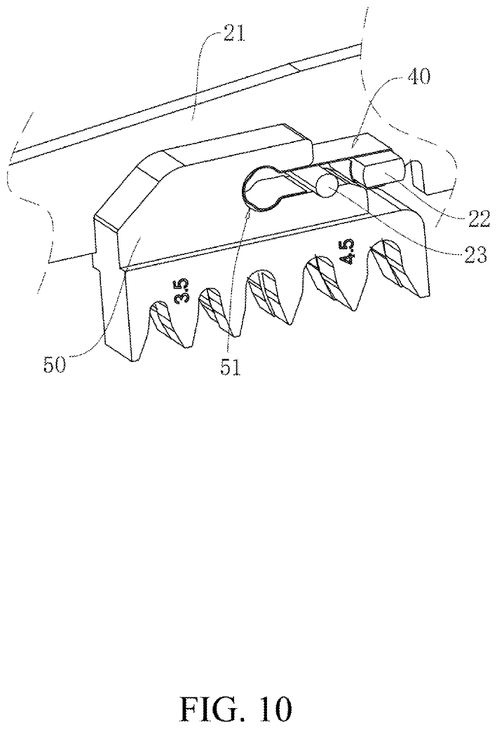

In some embodiments, referring to FIG. 6 to FIG. 10, the spare clamping block 50 is provided with a limiting groove 51. The limiting groove 51 has an opening 511, a channel portion 512, and a limiting portion 513 that are sequentially in communication. The opening 511 is located at a side portion of the spare clamping block 50 and is used for allowing the elastic limiting assembly 40 to enter. The channel portion 512 extends inward from the opening 511 and is used for allowing the elastic limiting assembly 40 to pass through. The limiting portion 513 is located at the end of the channel portion 512 and is used for catching the elastic limiting assembly 40.

The elastic limiting assembly 40 has a fixing component 41, a connecting component 42, and a limiting protrusion 43 that are sequentially arranged along the longitudinal direction of the respective two handle arms 21. The fixing component 41 is fixed to the handle assembly 20, for example, it can be connected to the handle arm 21 by means of screwing, riveting, gluing, winding, or binding. The connecting component 42 extends outward from the fixing component 41 and is at least partially disposed through the opening 511 and the channel portion 512 of the spare clamping block 50. The limiting protrusion 43 is located at the end of the connecting component 42, and its dimension is larger than the width of the channel portion 512, so that it can be caught in the limiting portion 513, thereby preventing the spare clamping block 50 from easily coming off.

When it is necessary to install the spare clamping block 50, the user aligns the opening 511 of the limiting groove 51 with the limiting protrusion 43 and then applies pressure to cause the elastic limiting assembly 40 to undergo elastic deformation. The limiting protrusion 43 passes through the opening 511 and the channel portion 512 and finally enters the limiting portion 513. Within the limiting portion 513, the limiting protrusion 43 returns to its original shape and forms interference with the inner wall of the limiting portion 513, thereby fixing the spare clamping block 50. During disassembly, the user pulls it out forcefully, causing the limiting protrusion 43 to deform again and slide out of the limiting portion 513.

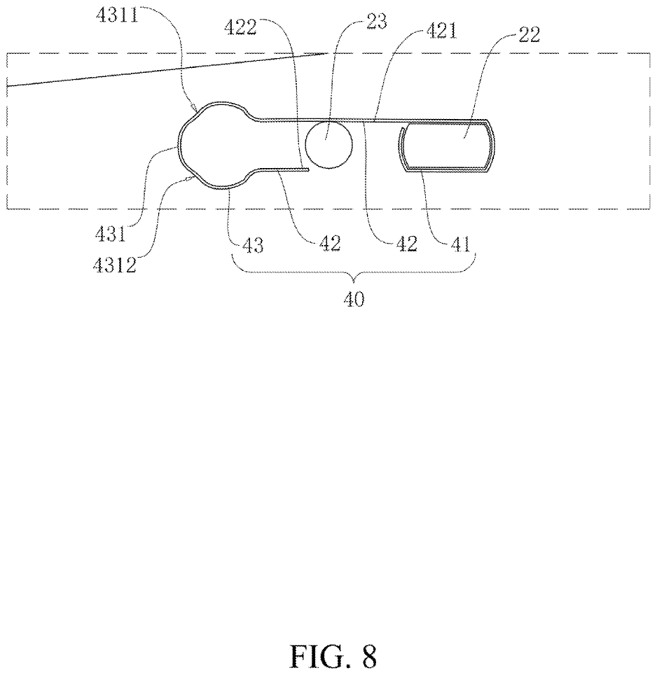

In some embodiments, referring to FIG. 6 and FIG. 8, when observed in a direction perpendicular to the longitudinal direction of the respective two handle arms 21, the dimension of the limiting protrusion 43 is larger than that of the connecting component 42. That is, the limiting protrusion 43 is wider than the connecting component 42, forming a shape similar to a mushroom head. Correspondingly, the limiting portion 513 of the spare clamping block 50 is adapted to the limiting protrusion 43 (i.e., the inner cavity dimension of the limiting portion 513 is slightly larger than the outer contour dimension of the limiting protrusion 43), and the channel portion 512 is adapted to the connecting component 42 (i.e., the width of the channel portion 512 is slightly larger than the width of the connecting component 42). This dimensional fit enables the limiting protrusion 43 to be firmly locked in the limiting portion 513, thereby achieving reliable fixation.

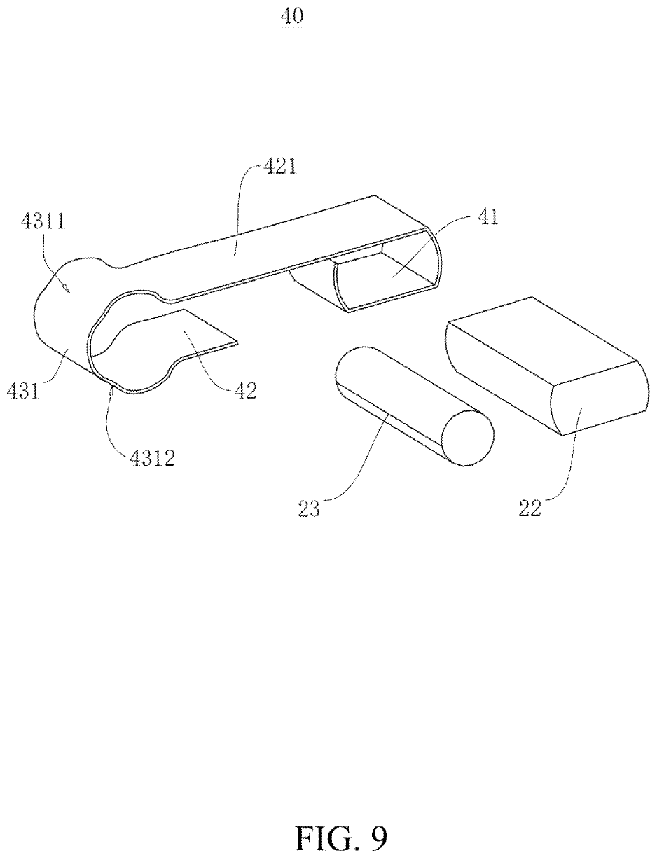

In some embodiments, referring to FIG. 6, FIG. 8, and FIG. 9, the free end of the limiting protrusion 43 facing away from the fixing component 41 is provided with a guiding portion 431. Along the direction of the limiting protrusion 43 toward the fixing component 41 (i.e., from the free end to the fixed end), the dimension of the limiting protrusion 43 in the direction perpendicular to the longitudinal direction of the respective two handle arms 21 gradually increases. That is, the front end of the limiting protrusion 43 is thinner and the rear end is thicker, forming a tapered or wedge-shaped structure. Meanwhile, the opening 511 of the spare clamping block 50 is provided with an inclined mating surface 5112. When the limiting protrusion 43 passes through the opening 511, the guiding portion 431 abuts against the mating surface 5112, and the mating surface 5112 compresses the guiding portion 431 toward the center, causing the limiting protrusion 43 to undergo elastic deformation, thereby smoothly passing through the opening 511. This guiding design significantly reduces assembly resistance, enabling the user to easily insert the spare clamping block 50.

In some embodiments, referring to FIG. 6 to FIG. 10, the guiding portion 431 has a first guiding surface 4311 and a second guiding surface 4312 that are oppositely disposed in a direction perpendicular to the longitudinal direction of the respective two handle arms 21. The first guiding surface 4311 and the second guiding surface 4312 are arranged at an included angle (for example, forming an acute angle or an obtuse angle, forming a pointed top or a rounded top). The mating surface 5112 of the spare clamping block 50 is configured to abut against the first guiding surface 4311 or the second guiding surface 4312 when the limiting protrusion 43 passes through the opening 511. This design of guiding surfaces further helps reduce assembly resistance and further improves the convenience of inserting the spare clamping block 50.

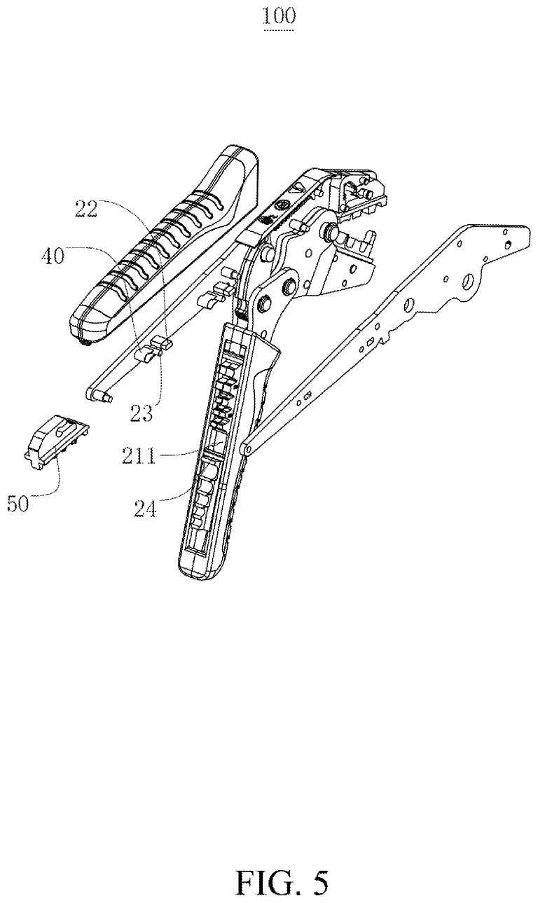

In some embodiments, referring to FIG. 5, FIG. 8, and FIG. 9, the handle assembly 20 includes a first fixing component 22. The first fixing component 22 is connected to the handle arm 21 and is located in the receiving groove 211. The first fixing component 22 may be a separate metal piece or plastic piece, and its shape may be rod-shaped or block-shaped. The first fixing component 22 may be connected to the handle arm 21 by integral molding or may be fixed to the handle arm 21 by screws or buckles; no specific limitation is made here. The elastic limiting assembly 40 is of a spring plate structure, and its fixing component 41 is fixed around the first fixing component 22 (for example, the fixing component 41 may be an annular ring fitted over the outer periphery of the first fixing component 22). The limiting protrusion 43 is in the shape of an annular spring plate. The connecting component 42 is located between the fixing component 41 and the limiting protrusion 43 and connects the two. This annular spring plate structure has good elastic uniformity and can provide balanced clamping force in the circumferential direction.

In some embodiments, referring to FIG. 5, FIG. 8, and FIG. 9, the handle assembly 20 further includes a second fixing component 23. The second fixing component 23 is also connected to the handle arm 21 and is located in the receiving groove. The second fixing component 23 may be arranged at an interval from the first fixing component 22 along the longitudinal direction of the respective two handle arms 21. The connecting component 42 includes a first part 421 and a second part 422. The first part 421 connects the fixing component 41 and the limiting protrusion 43, and the second part 422 further extends from the limiting protrusion 43, with the end of the second part 422 away from the limiting protrusion 43 being separated from the fixing component 41 (i.e., the second part 422 is suspended). When observed in a direction perpendicular to the longitudinal direction of the respective two handle arms 21, the first part 421 is located on the outer side of the second fixing component 23. This arrangement enables the second fixing component 23 to provide support and limiting functions. On the one hand, it reduces the risk of excessive deformation of the elastic limiting assembly 40 when under pressure. On the other hand, it helps prevent the spare clamping block 50 from falling off due to gravity. Furthermore, when inserting the spare clamping block 50 into the elastic limiting assembly 40, because the second part 422 adopts a suspended design, it is easier for the connecting component 42 of the elastic limiting assembly 40 to bend outward, causing the limiting protrusion 43 to tilt downward, thereby forming an angle favorable for the insertion of the spare clamping block 50 and further improving the convenience of insertion.

Contrary to the previous embodiment, in another layout, when observed in a direction perpendicular to the longitudinal direction of the respective two handle arms 21, the first part 421 is located on the inner side of the second fixing component 23. In this case, it is also beneficial to prevent the spare clamping block 50 from falling off due to gravity.

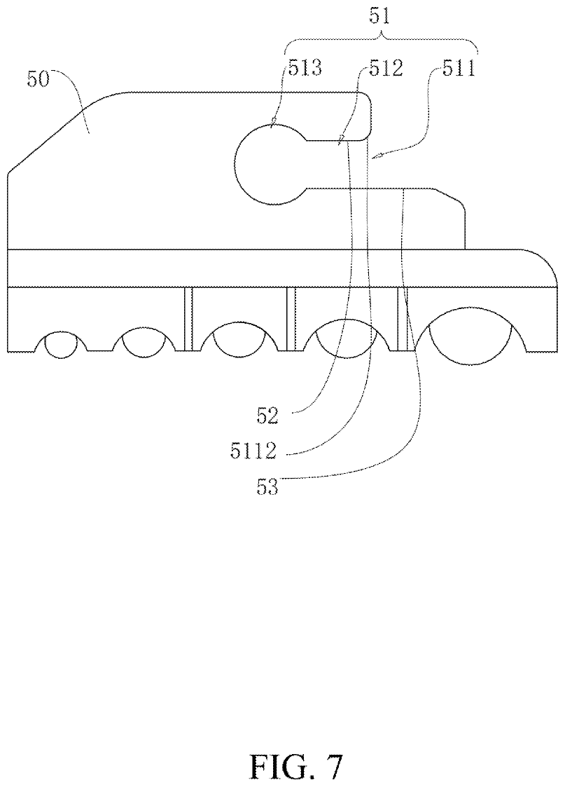

In some embodiments, referring to FIG. 7, the spare clamping block 50 includes a first wall 52 and a second wall 53 that are oppositely arranged. The first wall 52 and the second wall 53 jointly define the opening 511 and the channel portion 512. The length of the second wall 53 is greater than the length of the first wall 52, i.e., the second wall 53 is longer than the first wall 52. When observed in a direction perpendicular to the longitudinal direction of the respective two handle arms 21, the projection of the second wall 53 at least partially overlaps with the projections of the first fixing component 22 and the second fixing component 23. While the projection of the first wall 52 is spaced apart from the projections of both the first fixing component 22 and the second fixing component 23. This asymmetric design enables the longer second wall 53 of the spare clamping block 50, after installation, to easily abut against the first fixing component 22 and the second fixing component 23, which is beneficial for reducing the risk of the spare clamping block 50 tilting and coming off.

In some embodiments, both of the two handle arms 21 are provided with receiving grooves 211, and each receiving groove 211 extends along the longitudinal direction of the respective two handle arms 21. A plurality of elastic limiting assemblies 40 are arranged in each receiving groove 211, and these elastic limiting assemblies 40 are spaced apart along the longitudinal direction of the respective two handle arms 21. The number of spare clamping blocks 50 matches the number of elastic limiting assemblies 40, i.e., each elastic limiting assembly 40 correspondingly fixes one spare clamping block 50. In this way, the user can store spare clamping blocks 50 of multiple sizes on the same handle arm 21, for example, placing small, medium, and large clamping blocks sequentially from left to right, which is convenient for quick access.

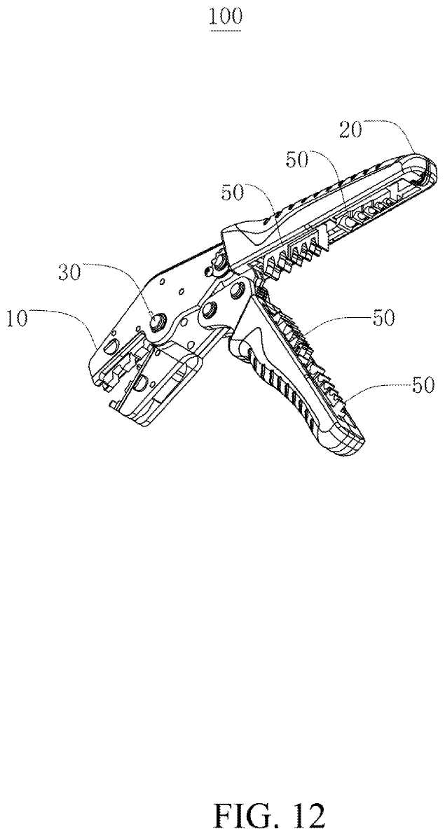

In some embodiments, referring to FIG. 12, each of the handle arms 21 is provided with two spare clamping blocks 50 stored thereon.

In some embodiments, referring to FIG. 4 and FIG. 5, the handle assembly 20 further includes at least one spacer 24. The spacer 24 is connected to the handle arm 21 and is located between any two adjacent elastic limiting assemblies 40. The spacer 24 may be a raised rib or an independent block-shaped structure for separating adjacent spare clamping blocks 50. The spacer 24 can serve as a positioning reference to assist the user in accurately snapping the spare blocks clamping 50 into the corresponding positions of the elastic limiting assemblies 40.

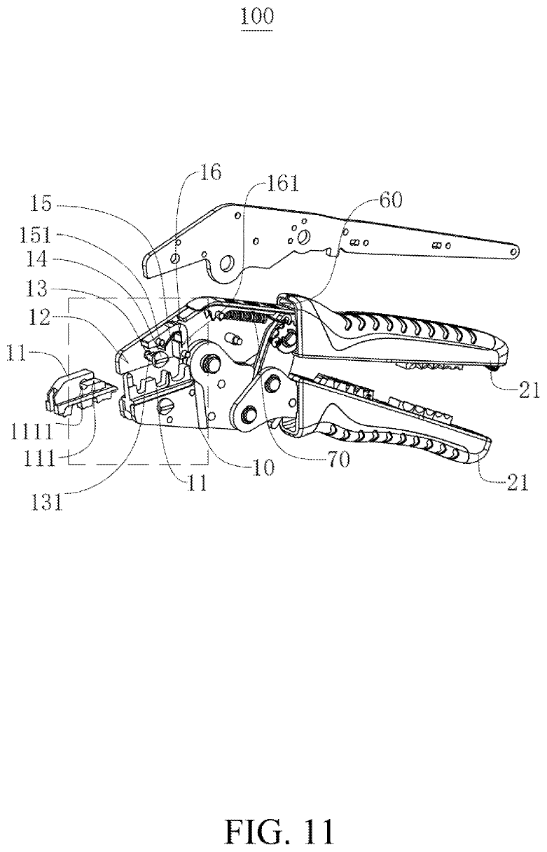

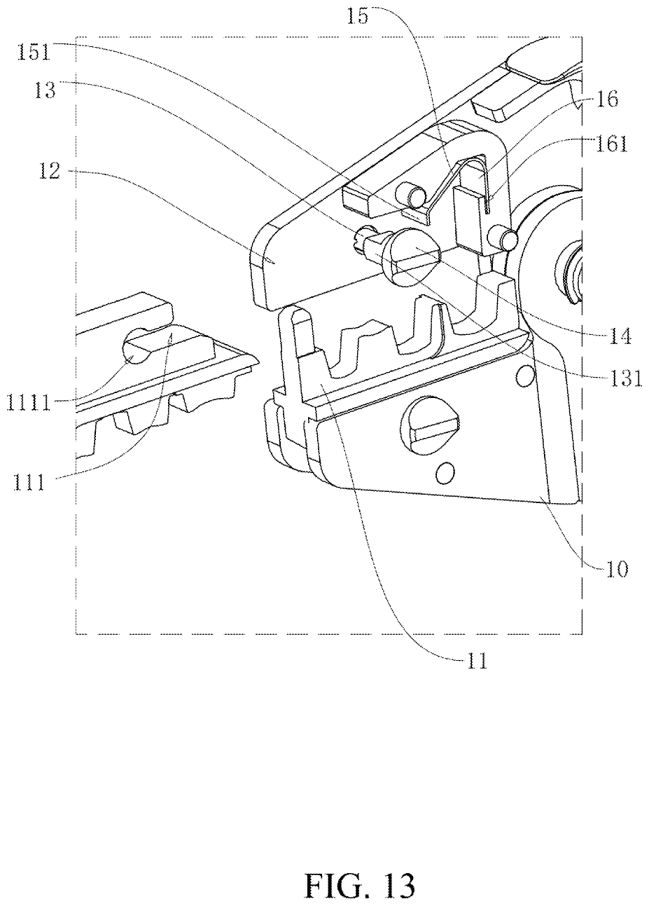

In some embodiments, referring to FIG. 11 and FIG. 13, a mounting recess 12 is formed at the port of the jaw assembly 10, and a portion of the clamping block 11 is inserted into the mounting recess 12. A rotatable rotary locking shaft 13 is disposed in the mounting recess 12. One end of the rotary locking shaft 13 is provided with an operating knob 14, which is located outside the jaw assembly 10 for convenient manual rotation by the user. The clamping block 11 is provided with an insertion port 111, and the bottom of the insertion port 111 is provided with a locking circular hole 1111. At the position of the rotary locking shaft 13 corresponding to the insertion port 111, an elliptical cylindrical locking block 131 is provided. The diameter of the locking block 131 varies according to the elliptical cylindrical shape, ranges from a minimum diameter to a maximum diameter, and the minimum diameter is smaller than the diameter of the insertion port 111. The maximum diameter is larger than the diameter of the insertion port 111 but smaller than the diameter of the locking circular hole 1111.

When installing the clamping block 11, the insertion port 111 of the clamping block 11 is first aligned with the rotary locking shaft 13 such that the minimum-diameter direction of the locking block 131 is aligned with the width direction of the insertion port 111. At this time, the locking block 131 can smoothly pass through the insertion port 111 and enter the locking circular hole 1111. Then, the operating knob 14 is rotated so that the maximum-diameter direction of the locking block 131 is offset from the width direction of the insertion port 111. Since the maximum diameter of the locking block 131 is larger than the diameter of the insertion port 111, the locking block 131 cannot exit from the insertion port 111, thereby locking the clamping block 11 securely within the mounting recess 12. During disassembly, reverse rotation is performed. This quick-release structure requires no tools and is simple and quick to operate.

In some embodiments, referring to FIG. 11 and FIG. 13, at least one spring plate 15 is further installed in the mounting recess 12, and the inner end of the clamping block 11 abuts against the spring plate 15. When the clamping block 11 is fixed by the locking block 131, the spring plate 15 is compressed and applies an outward pushing force to the clamping block 11, causing the clamping block 11 to closely abut against the locking block 131, thereby eliminating any clearance and preventing the clamping block 11 from shaking during operation. At the same time, during unlocking, the elastic force of the spring plate 15 can assist in ejecting the clamping block 11, facilitating its removal.

In some embodiments, referring to FIG. 11, the spring plate 15 is of a C-shape, and one end of the spring plate 15 close to the clamping block 11 is provided with a planar contact portion 151. The C-shaped structure provides good elastic deformation capability, while the planar contact portion 151 increases the contact area with the clamping block 11, avoids damaging the surface of the clamping block 11, and ensures a stable direction of the pushing force.

In some embodiments, referring to FIG. 11, the bottom of the mounting recess 12 is provided with a slot 16 that matches the shape of the spring plate 15. The spring plate 15 is placed in the slot 16, and the end of the spring plate 15 having the planar contact portion 151 is positioned outside the slot 16 (i.e., protruding from the slot 16 to contact the clamping block 11). The slot 16 is provided with an slice slot 161, and the other end of the spring plate 15 opposite to the planar contact portion 151 is fitted into the slice slot 161. This dual-positioning manner ensures that the spring plate 15 will not shift or fall off during long-term use, thereby guaranteeing the reliability of the function of the spring plate 15.

In some embodiments, referring to FIG. 11, the crimping pliers 100 further includes a top cover 60 and a spring 70. The top cover 60 is arranged at the top of the crimping pliers 100, and the spring 70 is located below the top cover. The spring 70 is elastically connected to the two handle arms 21, and the top cover 60 is arranged above the spring 70. On the one hand, it reduces the possibility of partial fragments of the damaged spring from ejecting outward, which is beneficial to improving the safety of the crimping pliers 100 during use. On the other hand, it reduces the risk of external dust, water, oil, and other contaminants entering the interior of the crimping pliers 100, which is beneficial to extending the service life of the crimping pliers 100.

The above embodiments are merely preferred embodiments of the present disclosure and are not intended to limit the scope of protection of the present disclosure. Any non-substantive changes and substitutions made by those skilled in the art on the basis of the present disclosure shall fall within the scope of protection claimed by the present disclosure.

What is claimed is:

1. Crimping pliers, comprising:
a jaw assembly provided with at least two oppositely arranged and detachable clamping blocks, wherein the jaw assembly has a clamping state and an open state, and wherein, in the clamping state, the at least two clamping blocks clamp against each other or against other components of the jaw assembly;
a handle assembly connected to the jaw assembly, wherein the handle assembly is configured to drive the jaw assembly to switch between the clamping state and the open state upon application of an external force, and wherein the handle assembly defines a receiving groove;
a pivoting assembly pivotably connecting the jaw assembly and the handle assembly;
an elastic limiting assembly fixed to the handle assembly and located within the receiving groove; and
a spare clamping block detachably snap-fitted to the elastic limiting assembly and located within the receiving groove.

2. The crimping pliers according to claim 1, wherein the handle assembly comprises two handle arms configured to move toward and away from each other to drive the jaw assembly to switch between the clamping state and the open state;
wherein at least one of the two handle arms defines the receiving groove, and wherein at least one elastic limiting assembly is disposed in each receiving groove.

3. The crimping pliers according to claim 2, wherein the spare clamping block is provided with a limiting groove, and the limiting groove comprises an opening, a channel portion and a limiting portion in sequential communication;
the elastic limiting assembly comprises a fixing component, a connecting component and a limiting protrusion arranged sequentially along a longitudinal direction of the respective two handle arms;
wherein the fixing component is fixed to the handle assembly, the connecting component extends at least partially through the opening and the channel portion, and the limiting protrusion is snap-fitted in the limiting portion.

4. The crimping pliers according to claim 3, wherein, along a direction perpendicular to the longitudinal direction of the respective two handle arms, a dimension of the limiting protrusion is larger than a dimension of the connecting component;
wherein the limiting portion is shaped to correspond to the limiting protrusion, and the channel portion is shaped to correspond to the connecting component.

5. The crimping pliers according to claim 4, wherein an end of the limiting protrusion facing away from the fixing component is provided with a guiding portion, and wherein in a direction from the limiting protrusion toward the fixing component, the dimension of the limiting protrusion, perpendicular to the longitudinal direction of the respective two handle arms, gradually increases;
the opening of the spare clamping block comprises an inclined mating surface configured to abut against the guiding portion as the limiting protrusion passes through the opening.

6. The crimping pliers according to claim 5, wherein the guiding portion comprises a first guiding surface and a second guiding surface oppositely disposed in the direction perpendicular to the longitudinal direction of the respective two handle arms, and wherein the first guiding surface and the second guiding surface form an included angle;
wherein the mating surface is configured to abut against the first guiding surface or the second guiding surface when the limiting protrusion passes through the opening.

7. The crimping pliers according to claim 3, wherein the handle assembly further comprises at least one first fixing component each connected to one of the two handle arms, and the at least one first fixing component is located in the receiving groove;
the elastic limiting assembly is of a spring plate structure, the fixing component is fixed around the first fixing component, the limiting protrusion is an annular spring plate, and the connecting component is located between the fixing component and the limiting protrusion.

8. The crimping pliers according to claim 7, wherein the handle assembly comprises a second fixing component, the second fixing component is connected to the handle arm, and the second fixing component is located in the receiving groove;
the connecting component comprises a first part connecting the fixing component and the limiting protrusion, and a second part extending from the limiting protrusion, and an end of the second part away from the limiting protrusion is separated from the fixing component;
wherein along the direction perpendicular to the longitudinal direction of the respective two handle arms, the first part is located on an outer side of the second fixing component.

9. The crimping pliers according to claim 7, wherein the handle assembly comprises a second fixing component connected to the handle arm, and the second fixing component is located in the receiving groove;
the connecting component comprises a first part connecting the fixing component and the limiting protrusion and a second part extending from the limiting protrusion, and an end of the second part away from the limiting protrusion is separated from the fixing component;
wherein, along the direction perpendicular to the longitudinal direction of the respective two handle arms, the first part is located on an inner side of the second fixing component.

10. The crimping pliers according to claim 8, wherein the spare clamping block comprises a first wall and a second wall oppositely arranged, and the first wall and the second wall form the opening and the channel portion;
the second wall is longer than the first wall, in a view perpendicular to the longitudinal direction of the respective two handle arms, the projection of the second wall at least partially overlaps with projections of the first fixing component and the second fixing component, and a projection of the first wall is separated from the projections of both the first fixing component and the second fixing component.

11. The crimping pliers according to claim 2, wherein each of the two handle arms is provided with the receiving groove extending along the longitudinal direction of the respective two handle arms, a plurality of the elastic limiting assemblies are provided in each receiving groove, the plurality of elastic limiting assemblies are arranged at intervals along the longitudinal direction of the respective two handle arms, and wherein the number of the spare clamping blocks corresponds to the number of the plurality of elastic limiting assemblies.

12. The crimping pliers according to claim 11, wherein the handle assembly comprises at least one spacer, the at least one spacer is connected to each of the two handle arms, and the spacer is provided between any two adjacent elastic limiting assemblies.

13. The crimping pliers according to claim 11, wherein a mounting recess is provided at a port of the jaw assembly, and a portion of the clamping block is inserted into the mounting recess;
a rotary locking shaft is provided in the mounting recess, and one end of the rotary locking shaft is provided with an operating knob and is placed outside the jaw assembly;
the clamping block is provided with an insertion port, and a bottom of the insertion port is defined with a locking circular hole; the rotary locking shaft is provided with a locking block at a position corresponding to the insertion port, the locking block has an elliptical cylindrical shape.

14. The crimping pliers according to claim 13, wherein at least one spring plate is installed in the mounting recess, and an inner end of the clamping block abuts against the spring plate.

15. The crimping pliers according to claim 14, wherein the spring plate is in a C-shape, and an end of the spring plate close to the clamping block is provided with a planar contact portion.

16. The crimping pliers according to claim 14, wherein a bottom of the mounting recess is provided with a clamping groove fitted in shape with the spring plate, the spring plate is placed in the clamping groove, and an end of the spring plate provided with the planar contact portion is placed outside the clamping groove;
a slice slot is provided in the clamping groove, and another end of the spring plate relative to the planar contact portion is fitted in the slice slot.

17. The crimping pliers according to claim 9, wherein the spare clamping block comprises a first wall and a second wall oppositely arranged, and the first wall and the second wall form the opening and the channel portion;
the second wall is longer than the first wall, in a view perpendicular to the longitudinal direction of the respective two handle arms, the projection of the second wall at least partially overlaps with projections of the first fixing component and the second fixing component, and a projection of the first wall is separated from the projections of both the first fixing component and the second fixing component.
